(19) United States
(12) Patent Application Publication
(10) Pub. No.: US 2015/0221918 A1
(43) Pub. Date: Aug. 6, 2015

(54) SEPARATOR FOR NON-AQUEOUS ELECTROLYTE SECONDARY BATTERY AND NON-AQUEOUS ELECTROLYTE SECONDARY BATTERY

(71) Applicant: SANYO Electric Co., Ltd., Daito-shi, Osaka (JP)

(72) Inventors: Nobuhiro Hirano, Osaka (JP); Isao Fujiwara, Osaka (JP); Masaru Watanabe, Hyogo (JP)

(73) Assignee: SANYO Electric Co., Ltd., Daito-shi, Osaka (JP)

(21) Appl. No.: 14/423,575

(22) PCT Filed: Jan. 31, 2014
(86) PCT No.: PCT/JP2014/000522

§ 371 Date: Feb. 24, 2015

(30) Foreign Application Priority Data
Jan. 31, 2013 (JP) 2013-017612
Jan. 31, 2013 (JP) 2013-017613

(51) Int. Cl. H01M 2/16; H01M 10/052

(52) U.S. Cl. CPC H01M 2/1626; H01M 10/052; H01M 2220/30; H01M 2220/20

(57) ABSTRACT

A separator for non-aqueous electrolyte secondary battery has a porous film mainly consisting of cellulose fiber, wherein the porous film has a maximum pore diameter of 0.2 μm or less.

### TECHNICAL FIELD

The present invention generally relates to a separator for non-aqueous electrolyte secondary battery and a non-aqueous electrolyte secondary battery.

### BACKGROUND ART

The size reduction and weight reduction of mobile information terminals such as cell phones and laptop personal computers are progressing rapidly, and non-aqueous electrolyte secondary batteries having a high energy density and a high capacity are being broadly utilized as drive power sources for such devices.

As separators for non-aqueous electrolyte secondary batteries, polyolefinic porous membranes as ones having a high airtightness and a large number of through-pores are conventionally used. Since polyolefins are low in heat resistance, however, when the internal temperature of a non-aqueous electrolyte secondary battery becomes high, shrinkage fracture portions and the like are generated in the porous membrane, and internal short circuit by contact of a positive electrode with a negative electrode arises at the shrinkage fracture portions and the like in some cases. To cope with this, there is a separator for non-aqueous electrolyte secondary battery using as a raw material a cellulose having high heat resistance.

For example, Patent Literature 1 discloses a separator for non-aqueous electrolyte secondary battery obtained by manufacturing a wet paper by using a cellulose as a raw material, and drying the wet paper while a void structure present in the wet paper is retained.

### CITATION LIST

### Patent Literature

Patent Literature 1: Japanese Patent Laid-Open Publication No. Hei 10-223196

### SUMMARY OF INVENTION

### Technical Problem

When charge/discharge is carried out repeatedly, or when overcharge is carried out, or in some other situations, metal lithium is deposited on a negative electrode surface in some cases. The deposit is called lithium dendrite. When the lithium dendrite gradually grows, penetrates a separator and reaches a positive electrode, it causes internal short circuit in some cases. Particularly in order to suppress lithium dendrite in the case where a negative electrode is composed of graphite, the pore diameter of a separator is preferably small. In a separator composed of cellulose fibers obtained by a measurement method described in Patent Literature 1, a sufficiently small pore diameter cannot be satisfied. Even conventional separator for non-aqueous electrolyte secondary batteries using cellulose as a raw material are not sufficient in terms of prevention of the internal short circuit caused by lithium dendrite.

It is therefore an object of the present invention to provide a separator for non-aqueous electrolyte secondary battery and a non-aqueous electrolyte secondary battery in which the occurrence of an internal short circuit is suppressed.

### Solution to Problem

The non-aqueous electrolyte secondary battery separator according to the present invention has a porous membrane containing cellulose fibers as its main component, wherein the maximum pore diameter of the porous membrane is 0.2 μm or smaller.

The non-aqueous electrolyte secondary battery according to the present invention comprises a positive electrode, a negative electrode, a separator for non-aqueous electrolyte secondary battery interposed between the positive electrode and the negative electrode, and a non-aqueous electrolyte, wherein the separator for non-aqueous electrolyte secondary battery has a porous membrane containing cellulose fibers as its main component, and the maximum pore diameter of the porous membrane is 0.2 μm or smaller.

### Advantageous Effects of Invention

According to the present invention, there can be provided a separator for non-aqueous electrolyte secondary battery and a non-aqueous electrolyte secondary battery in which the occurrence of an internal short circuit is suppressed.

### BRIEF DESCRIPTION OF DRAWINGS

FIG. 1 is a schematic cross section illustrating one example of a constitution of a non-aqueous electrolyte secondary battery according to the present embodiment.

FIG. 2 is a schematic cross section illustrating one example of a separator for non-aqueous electrolyte secondary battery according to the present embodiment.

### DESCRIPTION OF EMBODIMENTS

An embodiment of the present invention will be described hereinafter. The present embodiment is one example of carrying out the present invention, and the present invention is not limited to the present embodiment.

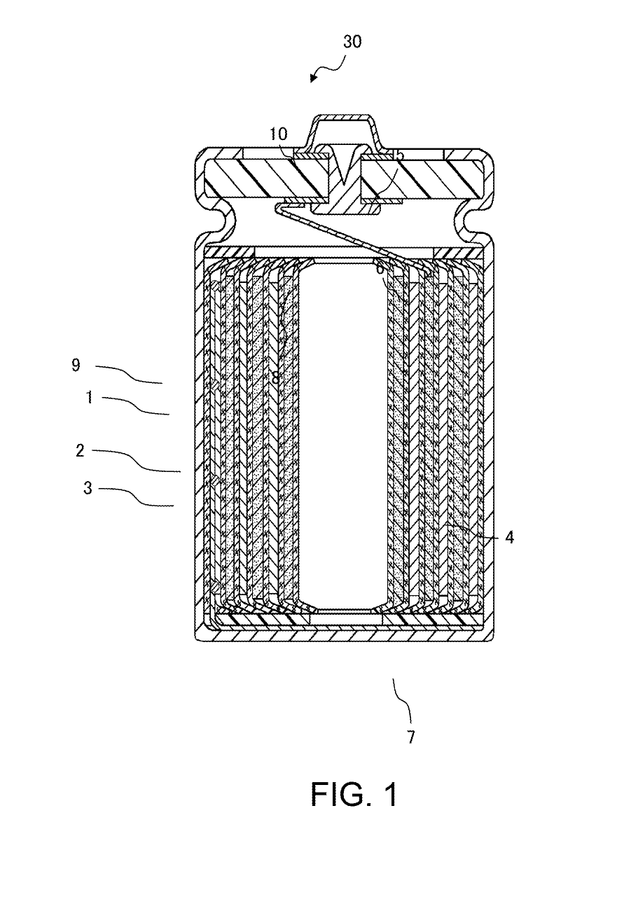

FIG. 1 is a schematic cross section illustrating one example of a constitution of a non-aqueous electrolyte secondary battery according to the present embodiment. A non-aqueous electrolyte secondary battery 30 illustrated in FIG. 1 comprises a negative electrode 1, a positive electrode 2, a separator for non-aqueous electrolyte secondary battery 3 (hereinafter, simply referred to as a separator 3 in some cases) interposed between the negative electrode 1 and the positive electrode 2, a non-aqueous electrolyte (not shown), a cylindrical battery case 4, and a sealing plate 5. The non-aqueous electrolyte is injected into the battery case 4. The negative electrode 1 and the positive electrode 2 are wound in a state of interposing the separator 3 between them, and constitute a wound-type electrode group together with the separator 3. On both ends in the longitudinal direction of the wound-type electrode group, an upper insulating plate 6 and a lower insulating plate 7 are installed, and are accommodated in the battery case 4. One end of a positive electrode lead 8 is connected to the positive electrode 2, and the other end of the positive electrode lead 8 is connected to a positive electrode terminal 10 provided on the sealing plate 5. One end of a negative electrode lead 9 is connected to the negative electrode 1, and the other end of the negative electrode lead 9 is connected to an internal bottom of the battery case 4. The connection of the leads to the members is carried out by welding or the like. An opening end of the battery case 4 is fixed to the sealing plate 5 by caulking to thereby seal the battery case 4.

### A Separator for Non-Aqueous Electrolyte Secondary Battery according to Embodiment 1

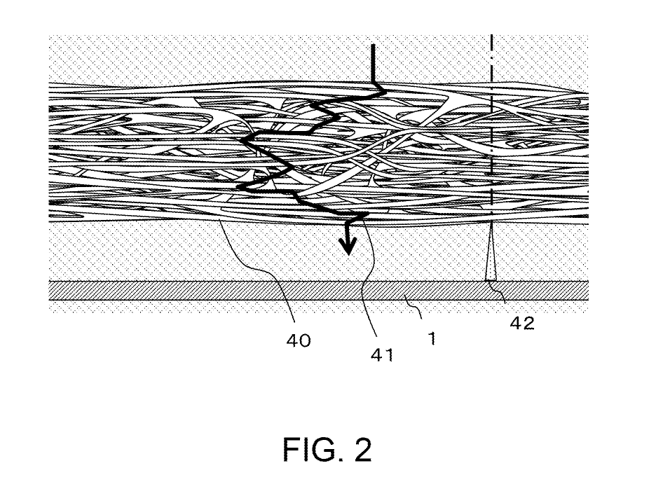

FIG. 2 is a schematic cross section illustrating one example of a constitution of a separator for non-aqueous electrolyte secondary battery according to the present embodiment. A separator 3 according to Embodiment 1 is interposed between a positive electrode 2 and a negative electrode 1, and has a function of Li ion permeation while preventing short circuit between the positive electrode 2 and the negative electrode 1. The separator 3 according to Embodiment 1 is constituted of a porous membrane containing cellulose fibers as its main component. The separator 3 according to Embodiment 1 is not limited to one constituted only of a porous membrane containing cellulose fibers as its main component, and may be, for example, one in which there is formed a porous layer or the like containing heat-resistant microparticles of iron oxide, SiO₂ (silica), Al₂O₃ (alumina), TiO₂ or the like as its main component on the porous membrane or in the porous membrane.

As illustrated in FIG. 2, in the porous membrane according to Embodiment 1, a plurality of pores to become paths 41 through which Li ions pass in the charge/discharge of a non-aqueous electrolyte secondary battery 30 are formed meanderingly. Then, in Embodiment 1, the maximum pore diameter of the porous membrane is in the range of 0.2 μm or smaller, and preferably in the range of 0.05 μm or smaller.

As described before, when charge/discharge is repeatedly carried out, or overcharge is carried out, or in some other situations, lithium dendrite 42 is generated on a surface of the negative electrode 1 in some cases. Then, when the lithium dendrite 42 gradually grows by a shortest distance toward the positive electrode, penetrates the separator and reaches the positive electrode 2, it causes an internal short circuit in some cases. As in the separator 3 according to Embodiment 1, however, by making fibers 40 be multi-bundled and the maximum pore diameter of the porous membrane be in the range of 0.2 μm or smaller, the compactness and the like of the membrane become high and the generation of internal short circuit caused by the generation of the lithium dendrite 42 is suppressed, compared with the case where the maximum pore diameter of the porous membrane exceeds 0.2 μm. Particularly by making the maximum pore diameter of the porous membrane be in the range of 0.05 μm or smaller, the mechanical strength, the compactness, the tortuosity and the like of the membrane are raised and the occurrence of an internal short circuit caused by the generation of the lithium dendrite 42 is better suppressed, compared with the case where the maximum pore diameter of the porous membrane exceeds 0.05 μm. Here, the tortuosity refers to a shape of a path of a pore connecting from one surface of the porous membrane to the opposite surface thereof, and a low tortuosity means that the number of through-pores perpendicular to the membrane is high, and may cause internal short circuit due to the lithium dendrite. Further from the viewpoint of the mechanical strength and the like of the membrane, the maximum pore diameter of the porous membrane is more preferably in the range of 0.03 μm or smaller. Further from the viewpoint of the reaction resistance of the non-aqueous electrolyte (electrolytic solution) in the battery, the lower limit value of the maximum pore diameter of the porous membrane is preferably made 0.02 μm or larger. Even if the maximum pore diameter is 0.02 μm or smaller, although the impregnation of the electrolytic solution can be carried out, lithium ions cannot migrate into the electrolytic solution in the charge time, thereby resulting in a battery which cannot be charged in some cases.

Further in the porous membrane according to Embodiment 1, in the pore diameter distribution of the porous membrane, pores having a pore diameter in the range of larger than 0.01 μm and 0.03 μm or smaller preferably account for the range of 10% or more and 50% or less of the entire pore volume, or pores having a pore diameter in the range of 0.01 μm or smaller preferably account for the range of 50% or more of the entire pore volume. When pores having a pore diameter in the range of larger than 0.01 μm and 0.03 μm or smaller account for a range of 10% or more and 50% or less of the entire pore volume, or pores having a pore diameter in the range of 0.01 μm or smaller account for a range of 50% or more of the entire pore volume, the mechanical strength, the compactness, the tortuosity and the like of the membrane are raised and the occurrence of internal short circuit caused by the generation of the lithium dendrite 42 is better suppressed. Further even if the proportion of pores having a pore diameter in the range of 0.01 μm or smaller is made to be in the above range, since pores to become paths 41 through which Li ions pass are secured, a remarkable decrease in the battery performance is suppressed. In consideration of the yield and the like in manufacture of the porous membrane, pores having a pore diameter in the range of 0.01 μm or smaller more preferably account for a range of 50% or more and 80% or less of the entire pore volume.

Further, in the pore diameter distribution of the porous membrane, if pores having a pore diameter in the range of larger than 0.01 μm account for more than 50% of the entire pore volume (pores having a pore diameter in the range of 0.01 μm or smaller account for less than 50% of the entire pore volume), the mechanical strength, the compactness, the tortuosity and the like of the membrane are decreased in some cases, compared with the case where pores having a pore diameter in the range of 0.01 μm or smaller account for 50% or more of the entire pore volume.

The pore diameter distribution of the porous membrane is measured, for example, by using a Perm-Porometer capable of measuring the pore diameter by a bubble point method (JIS K3832, ASTM F316-86). Specifically, pores up to 0.01 μm can be measured by using the Perm-Porometer (made by Seika Corp., CFP-1500AE type), using SILWICK (20 dyne/cm) or GALKWICK (16 dyne/cm) being a solvent low in surface tension as a test solution, and pressuring dry air up to a measurement pressure of 3.5 MPa, and the pore diameter distribution is acquired from an air passing amount at the measurement pressure at this time.

Here, the maximum pore diameter of the porous membrane refers to a maximum pore diameter in peaks observed in a pore diameter distribution acquired as in the above. Further by determining a proportion (B/A) of peak areas (B) observed as pores of a pore diameter of 0.01 μm or smaller to entire peak areas (A) observed from the pore diameter distribution acquired as in the above, what percentage of the entire pore volume the pores having a pore diameter of, for example, 0.01 μm or smaller account for may be determined.

The porous membrane according to Embodiment 1 preferably has one peak in the range of a pore diameter of 0.2 μm or smaller, preferably in the range of a pore diameter of 0.05 μm or smaller, in a pore diameter distribution measured by a Perm-Porometer.

Further in Embodiment 1, the thickness of the porous membrane is preferably in the range of 5 μm or larger and 30 μm or smaller, from the viewpoint of the charge/discharge performance improvement and the like of the secondary battery in addition to the mechanical strength and the like of the membrane. When the thickness of the porous membrane is 5 μm or larger, compared with the case where the thickness of the porous membrane is smaller than 5 μm, the mechanical strength of the membrane is improved, or through-pores perpendicular to the membrane are scarcely formed in the membrane to thereby further suppress the occurrence of an internal short circuit caused by the generation of lithium dendrite. When the thickness of the porous membrane is 30 μm or smaller, a decrease in the charge/discharge performance is suppressed compared with the case where the thickness of the porous membrane is larger than 30 μm.

In the porous membrane according to Embodiment 1, the fiber diameter of cellulose fibers 40 as the main component is preferably 1/10^{th} or less of the thickness of the porous membrane. Thereby, the fibers combined with each other and multi-bundled 40 form many multi-bundled layers in the thickness direction and may raise the tortuosity.

In the porous membrane according to Embodiment 1, in order for the membrane thickness to be 5 μm or larger, and the fiber diameter of the cellulose fibers 40 to be 1/10th or less of the thickness of the porous membrane, the average fiber diameter is preferably 0.5 μm or smaller. Any method of checking the average fiber diameter herein may be used, as long as it involves visual check using SEM.

Further the porosity of the porous membrane according to Embodiment 1 is not especially limited, but is preferably, for example, in the range of 30% or higher and 70% or lower, from the viewpoint of maintaining the high charge/discharge performance, and other factors. Here, the porosity refers to a percentage of a total volume of the pores of the porous membrane to a volume of the porous membrane.

The permeability of the porous membrane according to Embodiment 1 is not especially limited, but is preferably, for example, in the range of 150 sec/100 cc or higher and 800 sec/100 cc or lower, from the viewpoint of maintaining the high charge/discharge performance, and other factors. The permeability is acquired by making air pass through the provided porous membrane in the perpendicular direction of the porous membrane surface under a constant pressure, and measuring a time taken for 100 cc of the air to pass.

Further the basis weight of the porous membrane according to Embodiment 1 is not especially limited, but is preferably, for example, in the range of 5 g/m² or more and 20 g/m² or less, from the viewpoint of improving the mechanical strength of the membrane, maintaining the high charge/discharge, and other factors.

The porous membrane according to Embodiment 1 may be any as long as it contains cellulose fibers as its main component. Here, containing cellulose fibers as its main component refers to containing 80% by mass or more of cellulose fibers with respect to the total amount of the porous membrane. That is, if 80% by mass or more of cellulose fibers is contained, the porous membrane may contain organic fibers and the like other than the cellulose fibers. The organic fibers other than the cellulose fibers may be constituted in a laminated state with the cellulose as the main component, or may be contained in a mixed state in the cellulose as the main component.

One example of a manufacturing method of the porous membrane according to Embodiment 1 will be described. First, cellulose fibers and the like are dispersed in an aqueous solvent to thereby prepare an aqueous dispersion liquid. The obtained aqueous dispersion liquid is coated on a surface of a base material (for example, glass plate or stainless steel plate) having a smooth surface, and dried to thereby remove the solvent, and a membrane (porous membrane) formed on the substrate is peeled off. By such a method, a porous membrane is obtained. Examples of the aqueous solvent include those containing a surfactant, a thickener and the like with their viscosity and disperse state adjusted. An organic solvent may further be added to the aqueous dispersion liquid from the viewpoint of forming pores in the porous membrane, and other factors. Examples of the organic solvent include polar solvents having high compatibility with water, including alcohols such as butanol, glycols such as glycerol, and N-methyl-pyrrolidone. Further by using a binder of an aqueous solution of CMC, PVA or the like, and a binder of an emulsion of SBR or the like, the viscosity of a slurry may be adjusted and the membrane strength of the porous membrane may be strengthened. Further, the strengthening of the membrane strength and the addition of the electric insulation may be achieved by mixing resin long fibers in a level not affecting the coatability of the slurry and subjecting to thermal calendar press to obtain a porous membrane to which resin fibers are fused, or by coating and filling the slurry according to the present invention to porous membranes having a large pore diameter of electric insulating porous bodies, such as commercially available nonwoven fabrics and papers, and of electroconductive porous bodies.

The cellulose fibers according to Embodiment 1 are not especially limited, but may be any ones including natural cellulose fibers of coniferous wood pulps, broadleaf wood pulps, esparto pulps, Manila hemp pulps, sisal hemp pulps, cotton pulps or the like and regenerated cellulose fibers such as Lyocell, obtained by spinning these natural cellulose fibers in an organic solvent.

The cellulose fibers according to Embodiment 1 are preferably fibrillated cellulose fibers from the viewpoint of pore diameter control and retainability of a non-aqueous electrolyte, the battery life and the like. The fibrillation refers to phenomena of disintegrating the above-mentioned fibers composed of a multi-bundled structural body of fine fibers into fine fibers (fibrils), and fluffing the surface of fibers, by frictional action or the like etc. The fibrillation is obtained by beating fibers using a beating machine or the like, such as a beater, a refiner or a mill, or by defibrating fibers using a bead mill, an extrusion kneader or a high-pressure shearing force.

From the viewpoint of making the maximum pore diameter of the porous membrane in the range of 0.2 μm or smaller, preferably in the range of 0.05 μm or smaller, and other viewpoints, there are preferably used cellulose fibers having a fiber diameter of, for example, 0.5 μm or smaller and a fiber length of, for example, 50 μm or shorter.

### A Separator for Non-Aqueous Electrolyte Secondary Battery according to Embodiment 2

A separator 3 according to Embodiment 2 is constituted of a porous membrane containing cellulose fibers as its main component, as in the separator according to Embodiment 1. Then, as illustrated in FIG. 2, in the porous membrane according to Embodiment 2, a plurality of pores to become paths 41 through which Li ions pass in the charge/discharge of a non-aqueous electrolyte secondary battery 30 are formed. Then, in Embodiment 2, the maximum pore diameter of the porous membrane is in the range of 0.2 μm or smaller, and in the pore diameter distribution of the porous membrane, pores having a pore diameter in the range of 0.05 μm or smaller account for 50% or more of the entire pore volume.

As described before, when the charge/discharge is repeatedly carried out, or the overcharge is carried out, or in other situations, lithium dendrite 42 is generated on a surface of the negative electrode 1 in some cases. Then, when the lithium dendrite 42 gradually grows by a shortest distance toward the positive electrode, penetrates the separator and reaches the positive electrode 2, it causes an internal short circuit in some cases. As in the separator 3 according to Embodiment 2, however, by making fibers 40 be multi-bundled, making the maximum pore diameter of the porous membrane be in the range of 0.2 μm or smaller, and making pores having a pore diameter in the range of 0.05 μm or smaller account for 50% or more of the entire pore volume in the pore diameter distribution of the porous membrane, the mechanical strength, the compactness, the tortuosity and the like of the membrane become high and the penetration of the lithium dendrite 42 through the separator and the occurrence of an internal short circuit are suppressed, compared with the case where the maximum pore diameter of the porous membrane exceeds 0.2 μm. Here, the tortuosity refers to a shape of paths of pores connecting from one surface of the porous membrane to the opposite surface thereof, and the tortuosity being low means that through-pores perpendicular to the membrane are many, and may cause internal short circuit due to the lithium dendrite. The cellulose fibers of the porous membrane according to Embodiment 2 is constituted in a high-order structure of fine fibers fluffed by the fibrillation giving a fiber diameter of 0.5 μm or smaller and a fiber length of 50 μm or shorter, to be thereby capable of forming the porous membrane which has a high tortuosity and is compact. Further, in consideration of the point of suppressing an output decrease of a non-aqueous electrolyte secondary battery while the mechanical strength and the like of the membrane are secured, and other points, the maximum pore diameter of the porous membrane according to Embodiment 2 is preferably in the range of 0.1 μm or larger and 0.2 μm or smaller, and in the pore diameter distribution of the porous membrane, pores having a pore diameter in the range of 0.05 μm or smaller more preferably account for a range of 50% or more and 80% or less of the entire pore volume.

When the maximum pore diameter of the porous membrane exceeds 0.2 μm, compared with the case where the maximum pore diameter of the porous membrane is 0.2 μm or smaller, the mechanical strength, the compactness, the tortuosity and the like of the porous membrane are decreased, the lithium dendrite penetrates the separator, and the internal short circuit is liable to occur. In the case where the maximum pore diameter is smaller than 0.1 μm, the input/output decreases in some cases. Further in the pore diameter distribution of the porous membrane, when pores having a pore diameter in the range of larger than 0.05 μm account for more than 50% of the entire pore volume (pores having a pore diameter in the range of 0.05 μm or smaller account for less than 50% of the entire pore volume), the mechanical strength, the compactness, the tortuosity and the like of the porous membrane are decreased, the lithium dendrite penetrates the separator, and the internal short circuit is liable to occur, compared with the case where pores having a pore diameter in the range of 0.05 μm or smaller account for 50% or more of the entire pore volume. In the pore diameter distribution of the porous membrane, when pores having a pore diameter in the range of larger than 0.05 μm account for less than 20%, the input/output decreases in some cases.

The pore diameter distribution of the porous membrane is measured, for example, by using a Perm-Porometer capable of measuring the pore diameter by a bubble point method (JIS K3832, ASTM F316-86). Specifically, pores up to 0.01 μm can be measured by using the Perm-Porometer (made by Seika Corp., CFP-1500AE type), using SILWICK (20 dyne/cm) or GAKWICK (16 dyne/cm) being a solvent low in surface tension as a test solution, and pressurizing dry air up to a measurement pressure of 3.5 MPa, and the pore diameter distribution is acquired from an air passing amount at the measurement pressure at this time.

Here, the maximum pore diameter of the porous membrane refers to a maximum pore diameter in peaks observed in the pore diameter distribution acquired as in the above. Further by determining a proportion (B/A) of peak areas (B) observed as pores of a pore diameter of 0.05 μm or smaller to entire peak areas (A) observed from the pore diameter distribution acquired as in the above, it may be determined what percentage of the entire pore volume the pores having a pore diameter of 0.05 μm or smaller account for.

Regarding the pore diameter distribution measured by a Perm-Porometer, for example, the porous membrane according to Embodiment 2 preferably has a broad distribution of pore diameters over the range of 0.01 μm or larger and 0.2 μm or smaller, and preferably has one or more peaks in the pore diameters in the range of 0.01 μm or larger and 0.2 μm or smaller.

Further in Embodiment 2, the thickness of the porous membrane is preferably in the range of 5 μm or larger and 30 μm or smaller, from the viewpoint of the charge/discharge performance improvement and the like of a secondary battery, in addition to the mechanical strength and the like of the membrane. When the thickness of the porous membrane is 5 μm or larger, compared with the case where the thickness of the porous membrane is smaller than 5 μm, the mechanical strength of the membrane is improved, or through-pores perpendicular to the membrane are scarcely formed to thereby further suppress the occurrence of an internal short circuit caused by lithium dendrite. When the thickness of the porous membrane is 30 μm or smaller, a decrease in the charge/discharge performance is suppressed compared with the case where the thickness of the porous membrane is larger than 30 μm.

Further the porosity of the porous membrane according to Embodiment 2 is not especially limited, but is preferably, for example, in the range of 30% or higher and 70% or lower, from the viewpoint of maintaining high charge/discharge performance, and other factors. Here, the porosity refers to a percentage of a total volume of the pores of the porous membrane to a volume of the porous membrane.

The permeability of the porous membrane according to Embodiment 2 is not especially limited, but is preferably, for example, in the range of 150 sec/100 cc or higher and 800 sec/100 cc or lower, from the viewpoint of maintaining the high charge/discharge performance, and other factors. The permeability is acquired by making air pass through the provided porous membrane in the perpendicular direction of the porous membrane surface under a constant pressure, and measuring a time taken for 100 cc of the air to pass.

Further the basis weight of the porous membrane according to Embodiment 2 is not especially limited, but is preferably, for example, in the range of 5 g/m² or more and 20 g/m² or less, from the viewpoint of improving the mechanical strength of the membrane, maintaining the high charge/discharge, and other factors.

The porous membrane according to Embodiment 2 is any as long as it contains cellulose fibers as its main component. Here, containing cellulose fibers as its main component means containing 80% by mass or more of cellulose fibers with respect to the total amount of the porous membrane. That is, if 80% by mass or more of cellulose fibers is contained, the porous membrane may contain organic fibers and the like other than the cellulose fibers. The organic fibers other than the cellulose fibers may be constituted in a laminated state with the cellulose as the main component, or may be contained in a mixed state in the cellulose as the main component.

One example of a manufacturing method of the porous membrane according to Embodiment 2 will be described. First, cellulose fibers and the like are dispersed in an aqueous solvent to thereby prepare an aqueous dispersion liquid. The obtained aqueous dispersion liquid is coated on a surface of a base material (for example, glass plate or stainless steel plate) having a smooth surface, and dried to thereby remove the solvent, and a membrane (porous membrane) formed on the substrate is peeled off. By such a method, a porous membrane is obtained. Examples of the aqueous solvent include ones containing a surfactant, a thickener and the like with their viscosity and disperse state adjusted. An organic solvent may further be added to the aqueous dispersion liquid, from the viewpoint of forming pores in the porous membrane, and other factors. The organic solvent is selected from ones having high compatibility with water, and examples thereof include polar solvents including glycols such as ethylene glycol, glycol ethers, glycol diethers and N-methyl-pyrrolidone. Further, by using a binder of an aqueous solution of CMC, PVA or the like, and a binder of an emulsion of SBR or the like, the viscosity of a slurry may be adjusted and the membrane strength of the porous membrane may be strengthened. Further, the strengthening of the membrane strength and the addition of the electric insulation may be achieved by mixing resin long fibers in a level not affecting the coatability of the slurry, and subjecting to thermal calendar press to obtain a porous membrane to which resin fibers are fused or by coating and filling the slurry according to the present invention into porous membranes having a large pore diameter of electric insulating porous bodies such as commercially available nonwoven fabrics and papers and of electroconductive porous bodies.

The cellulose fibers according to Embodiment 2 are not especially limited, but may be any ones including natural cellulose fibers of coniferous wood pulps, broadleaf wood pulps, esparto pulps, Manila hemp pulps, sisal hemp pulps, cotton pulps or the like, and regenerated cellulose fibers such as Lyocell, obtained by spinning these natural cellulose fibers in an organic solvent.

The cellulose fibers according to Embodiment 2 are preferably fibrillated cellulose fibers from the viewpoint of pore diameter control and retainability of a non-aqueous electrolyte, the battery life and the like. The fibrillation refers to phenomena of disintegrating the above-mentioned fibers composed of a multi-bundled structural body of fine fibers into fine fibers (fibrils), and fluffing the surface of fibers, by a frictional action, and the like. The fibrillation is obtained by beating fibers using a beating machine or the like, such as a beater, a refiner and a mill, or by defibrating fibers using a bead mill, an extrusion kneader or a high-pressure shearing force.

In Embodiment 2, from the viewpoint of making the maximum pore diameter of the porous membrane 0.2 μm or smaller, and making pores having a pore diameter in the range of 0.05 μm or smaller be 50% or more of the entire pore volume, and other viewpoints, there are preferably used cellulose fibers having a fiber diameter of, for example, 0.5 μm or smaller, and a fiber length of, for example, 50 μm or shorter, and there are more preferably used cellulose fibers having a fiber diameter of, for example, 0.5 μm or smaller, and a fiber length of, for example, 50 μm or shorter and cellulose fibers having a fiber diameter of, for example, 0.5 μm or larger and 5.0 μm or smaller, and a fiber length of, for example, 50 μm or shorter. The cellulose fibers of the porous membrane according to Embodiment 2 are constituted by fine fibers fluffed by fibrillation giving a fiber diameter of 0.5 μm or smaller and a fiber length of 50 μm or shorter to be thereby capable of forming a compact pore diameter distribution having pore diameters of 0.05 μm or smaller. Further, the cellulose fibers are constituted by fibers fluffed by fibrillation giving a fiber diameter of 0.5 μm or larger and 5.0 μm or smaller and a fiber length of 50 μm or shorter to be thereby capable of forming a pore diameter distribution having pore diameters of 0.2 μm or smaller. The fiber diameter and the fiber length are measured by SEM observation. Alteration of the fiber diameter and the fiber length is made possible by changing the beating or defibration conditions.

Hereinafter, other constitutions of a non-aqueous electrolyte secondary battery 30 having the separator 3 according to Embodiment 1 or Embodiment 2 will be described.

The positive electrode 2 preferably comprises a positive electrode active substance such as a lithium-containing compound oxide. Examples of the lithium-containing compound oxide include lithium cobaltate, modified lithium cobaltates, lithium nickelate, modified lithium nickelates, lithium manganate and modified lithium manganates. The modified lithium cobaltates contain, for example, nickel, aluminum or magnesium. The modified lithium nickelates contain, for example, cobalt or manganese.

The positive electrode 2 comprises the positive electrode active substance as its essential component, and contains a binder and an electroconductive material as optional components. As the binder, for example, a polyvinylidene fluoride (PVDF), a modified PVDF, a polytetrafluoroethylene (PTFE) or modified acrylonitrile rubber particles are used. The PTFE and the rubber particles are desirably used in combination with, for example, a carboxymethylcellulose (CMC), a polyethylene oxide (PEO) or a soluble modified acrylonitrile rubber, which have a viscosity-increasing effect. As the electroconductive material, for example, acetylene black, Ketjen black or various types of graphite are used.

The negative electrode 1 preferably comprises a negative electrode active substance such as a carbon material like graphite, a silicon-containing material and a tin-containing material. Examples of graphite include natural graphite and artificial graphite. Metal Li, or a lithium alloy containing tin, aluminum, zinc, magnesium or the like may also be used.

The negative electrode 1 comprises the negative electrode active substance as its essential component, and contains a binder and an electroconductive material as optional components. As the binder, for example, a PVDF, a modified PVDF, a styrene-butadiene copolymer (SBR) or a modified SBR are used. Among these, from the viewpoint of the chemical stability, particularly a SBR and a modified SBR are preferable. The SBR and the modified SBR are preferably used in combination with a CMC, having a viscosity-increasing effect.

As the non-aqueous electrolyte, a non-aqueous solvent in which a lithium salt is dissolved is preferably used. As the lithium salt, for example, LiPF₆ or LiBF₄ may be used. As the non-aqueous solvent, for example, ethylene carbonate (EC), propylene carbonate (PC), dimethyl carbonate (DMC), diethyl carbonate (DEC) or ethyl methyl carbonate (EMC) may be used. These are preferably used in combination of two or more.

Here, the non-aqueous electrolyte secondary battery 30 in FIG. 1, though being a cylindrical battery comprising a wound-type electrode group, is not especially limited in the battery shape, and may be, for example, a rectangular battery, a flat battery, a button cell or a laminated film pack battery.

### EXAMPLES

Hereinafter, the present invention will be described more specifically in detail by way of Examples and Comparative Examples, but the present invention is not limited to the following Examples.

### Example 1

[Fabrication of a Positive Electrode]

Lithium cobaltate as a positive electrode active substance, acetylene black as an electroconductive agent, and a polyvinylidene fluoride as a binder were mixed so as to be 95% by mass, 2.5% by mass and 2.5% by mass, respectively, and N-methyl-2-pyrrolidone was added to the mixture to thereby make a slurry. Thereafter, the slurry was applied on an aluminum foil current collector being a positive electrode current collector, and vacuum dried at 110° C. to thereby fabricate a positive electrode.

[Fabrication of a Negative Electrode]

As a negative electrode, a metal lithium foil of 300 μm in thickness was used.

[Fabrication of a Non-Aqueous Electrolyte]

4-fluoroethylene carbonate (hereinafter, referred to as FEC) as a fluorinated cyclic carbonate ester and methyl trifluoropropionate (hereinafter, referred to as FMP) as a fluorinated chain ester were mixed so as to be in a proportion in volume ratio of 25:75 to thereby obtain a non-aqueous solvent. Lithium hexafluorophosphate (hereinafter, referred to as LiPF₆) as an electrolyte salt was dissolved so as to be in a concentration of 1.0 mol/l in the non-aqueous solvent to thereby fabricate a non-aqueous electrolyte.

[Fabrication of a Separator]

100 parts by mass of cellulose fibers A having a fiber diameter of 0.1 μm or smaller and a fiber length of 50 μm or shorter were dispersed in 100 parts by mass of water, then 5 parts by mass of ethylene glycol was added to thereby prepare an aqueous dispersion liquid. The aqueous dispersion liquid was coated on a glass substrate, and dried at 110° C. Thereafter, a membrane formed on the glass substrate was peeled off to thereby obtain a porous membrane 1. The porous membrane 1 was made to be a separator 1. In the pore diameter distribution of the porous membrane 1 measured by a Perm-Porometer, pores having a pore diameter in the range of larger than 0.01 μm and 0.03 μm or smaller accounted for 20% of the entire pore volume, and the maximum pore diameter of the porous membrane was 0.03 μm. The membrane thickness of the porous membrane was 30 μm.

The fabricated positive electrode and negative electrode were laminated so as to face each other with the separator 1 interposed therebetween, and the electrode group together with the non-aqueous electrolyte was sealed in a button cell, in a dry box. A test cell A1 was thus fabricated which was a non-aqueous electrolyte secondary battery having a rated capacity of 3 mAh.

### Example 2

A porous membrane 2 was fabricated as in Example 1, except for adding 100 parts by mass of the cellulose fibers A and 30 parts by mass of ethylene glycol, and was made to be a separator 2. In the pore diameter distribution of the porous membrane 2 measured by a Perm-Porometer, pores having a pore diameter in the range of larger than 0.01 μm and 0.03 μm or smaller accounted for 15% of the entire pore volume, and the maximum pore diameter of the porous membrane was 0.04 μm. The membrane thickness of the porous membrane was 30 μm. Then, a test cell was fabricated as in Example 1, except for using the separator 2, and was made to be a test cell A2.

### Example 3

A porous membrane 3 was fabricated as in Example 1, except for adding 100 parts by mass of the cellulose fibers A and 50 parts by mass of ethylene glycol, and was made to be a separator 3. In the pore diameter distribution of the porous membrane 3 measured by a Perm-Porometer, pores having a pore diameter in the range of larger than 0.01 μm and 0.03 μm or smaller accounted for 10% of the entire pore volume, and the maximum pore diameter of the porous membrane was 0.05 μm. The membrane thickness of the porous membrane was 30 μm. Then, a test cell was fabricated as in Example 1, except for using the separator 3, and was made to be a test cell A3.

### Example 4

A porous membrane 4 having a membrane thickness of 5 μm was fabricated as in Example 1, and was made to be a separator 4. In the pore diameter distribution of the porous membrane 4 measured by a Perm-Porometer, pores having a pore diameter in the range of larger than 0.01 μm and 0.03 μm or smaller accounted for 20% of the entire pore volume, and the maximum pore diameter of the porous membrane was 0.03 μm. Then, a test cell was fabricated as in Example 1, except for using the separator 4, and was made to be a test cell A4.

### Example 5

A porous membrane 5 was fabricated as in Example 1, except for using cellulose fibers B having a fiber diameter of 0.5 μm or smaller and a fiber length of 50 μm or shorter, and was made to be a separator 5. In the pore diameter distribution of the porous membrane 5 measured by a Perm-Porometer, pores having a pore diameter in the range of larger than 0.01 μm and 0.03 μm or smaller accounted for 10% of the entire pore volume, and the maximum pore diameter of the porous membrane was 0.05 μm. The membrane thickness of the porous membrane was 30 μm. Then, a test cell was fabricated as in Example 1, except for using the separator 5, and was made to be a test cell A5.

### Comparative Example 1

A porous membrane 6 having a membrane thickness of 30 μm was fabricated as in Example 1, except for altering the fibers to cellulose fibers C having a fiber diameter of 2 μm, and was made to be a separator 6. In the pore diameter distribution of the porous membrane 6 measured by a Perm-Porometer, pores having a pore diameter in the range of larger than 0.01 μm and 0.03 μm or smaller accounted for 0% of the entire pore volume, and the maximum pore diameter of the porous membrane was 0.4 μm. Then, a test cell was fabricated as in Example 1, except for using the separator 6, and was made to be a test cell A6.

Table 1 shows the maximum pore diameters and the ratios of pores having a pore diameter in the range of larger than 0.01 μm and 0.03 μm or smaller of the porous membranes in Examples 1 to 5 and Comparative Example 1.

TABLE 1

| | | | Porous Membrane | | | |
|---|---|---|---|---|---|---|
| | Fiber | | Maximum | Ratio of Pores Having | | Cycle Number |
| | | Average Fiber | Pore | a Pore Diameter of | Membrane | until Short |
| | | Diameter | Diameter | 0.01 to 0.03 μm or | Thickness | Circuit |
| | Fiber | μm | (μm) | Smaller (%) | (μm) | (numbers) |
| Example 1 | A | 0.1 μm or smaller | 0.03 | 20 | 30 | no short circuit |
| Example 2 | A | 0.1 μm or smaller | 0.04 | 15 | 30 | no short circuit |
| Example 3 | A | 0.1 μm or smaller | 0.05 | 10 | 30 | no short circuit |
| Example 4 | A | 0.1 μm or smaller | 0.03 | 20 | 5 | no short circuit |
| Example 5 | B | 0.5 μm or smaller | 0.05 | 10 | 30 | no short circuit |
| Comparative | C | 2 μm | 0.4 | 0 | 30 | 1 |
| Example 1 | | | | | | |

[Evaluation of the Internal Short Circuit]

The fabricated test cells A1 to A6 were each repeatedly subjected to a cycle of such charge/discharge that the test cell was charged at a constant current of 1.5 mA until the cell voltage reached 4.4 V, further charged at a constant voltage of 4.4 V until the current value became 0.01 mA, and thereafter, discharged at a constant current of 1.5 mA until the cell voltage reached 2.5 V.

As a result of the above repeated charge/discharge cycles, although in the test cell A6 of Comparative Example 1, a voltage decrease due to internal short circuit was observed in the charge time in the first cycle, in the test cells A1 to A5 of Examples 1 to 5, no capacity decrease due to internal short circuit was observed even after the course of 10 cycles. Then, when the test cells A1 to A5 of Examples 1 to 5 after the course of 10 cycles were disassembled, lithium dendrite was confirmed from the negative electrodes, but did not penetrate the separators in the any test cells, and no internal short circuit occurred. By contrast, when the test cell A6 of Comparative Example 1 in the charge time in the first cycle was disassembled, lithium dendrite penetrated the separator and internal short circuit had occurred. That is, by using a separator having a porous membrane with a maximum pore diameter of 0.05 μm or smaller, the occurrence of the internal short circuit caused by lithium dendrite was better suppressed than the case where a separator having a porous membrane having a maximum pore diameter of 0.4 μm or larger was used.

Particularly in the test cells A1 to A3 of Examples 1 to 3 and the test cell A5 of Example 5, further, no voltage decrease due to the internal short circuit was observed even after the course of 50 cycles. That is, by using a separator having a porous membrane in which pores having a pore diameter in the range of 0.01 μm or larger and 0.03 μm or smaller accounted for 10% to 50% of the entire pore volume in the pore diameter distribution of the porous membrane, and the membrane thickness was in the range of 5 μm or larger and 30 μm or smaller, the occurrence of the internal short circuit caused by lithium dendrite was better suppressed than the case of using a separator having a porous membrane out of the above range.

### Example 6

[Fabrication of a Positive Electrode]

Lithium cobaltate as a positive electrode active substance, acetylene black as an electroconductive agent, and a polyvinylidene fluoride as a binder were mixed so as to be 95% by mass, 2.5% by mass and 2.5% by mass, respectively, and N-methyl-2-pyrrolidone was added to the mixture to thereby make a slurry. Thereafter, the slurry was applied on an aluminum foil current collector being a positive electrode current collector, and dried to thereby fabricate a positive electrode.

[Fabrication of a Negative Electrode]

An artificial graphite as a negative electrode active substance, a sodium salt of a carboxymethylcellulose as a thickening agent and a styrene-butadiene copolymer as a binder were mixed so as to be 98% by mass, 1% by mass and 1% by mass, respectively, and water was added to the mixture to thereby make a slurry. Thereafter, the slurry was applied on a copper foil current collector being a negative electrode current collector, and dried to thereby fabricate a negative electrode.

[Fabrication of a Non-Aqueous Electrolyte]

4-fluoroethylene carbonate (hereinafter, referred to as FEC) as a fluorinated cyclic carbonate ester and methyl trifluoropropionate (hereinafter, referred to as FMP) as a fluorinated chain ester were mixed so as to be in a proportion in volume ratio of 25:75 to thereby obtain a non-aqueous solvent. Lithium hexafluorophosphate (hereinafter, referred to as LiPF₆) as an electrolyte salt was dissolved so as to be in a concentration of 1.0 mol/l in the non-aqueous solvent to thereby fabricate a non-aqueous electrolyte.

[Fabrication of a Separator]

70 parts by mass of cellulose fibers D having a fiber diameter of 0.5 μm or smaller and a fiber length of 50 μm or shorter and 30 parts by mass of cellulose fibers E having a fiber diameter of 0.5 μm or larger and 5 μm or smaller and a fiber length of 50 μm or shorter were dispersed in 100 parts by mass of water, then 5 parts by mass of an ethylene glycol solution was added to thereby prepare an aqueous dispersion liquid. The aqueous dispersion liquid was coated on a glass substrate, and dried. Thereafter, a membrane formed on the glass substrate was peeled off to thereby obtain a porous membrane 7. The porous membrane 7 was made to be a separator 7. In the pore diameter distribution of the porous membrane 7 measured by a Perm-Porometer, pores having a pore diameter in the range of 0.05 μm or smaller accounted for 60% of the entire pore volume, and the maximum pore diameter of the porous membrane 7 was 0.2 μm. The membrane thickness of the porous membrane 7 was 15 μm.

The fabricated positive electrode and negative electrode were wound so as to face each other with the separator 7 interposed therebetween to thereby fabricate an electrode group, and the electrode group together with the non-aqueous electrolyte was sealed in a laminated armored body, in a dry box. A test cell A7 was thus fabricated which was a non-aqueous electrolyte secondary battery having a rated capacity of 1,000 mAh.

### Example 7

A porous membrane 3 was fabricated as in Example 6, except for adding 80 parts by mass of the cellulose fibers D and 20 parts by mass of the cellulose fibers E, and was made to be a separator 8. In the pore diameter distribution of the porous membrane 8 measured by a Perm-Porometer, pores having a pore diameter in the range of 0.05 μm or smaller accounted for 80% of the entire pore volume, and the maximum pore diameter of the porous membrane S was 0.1 μm. The membrane thickness of the porous membrane 8 was 20 μm. Then, a test cell was fabricated as in Example 6, except for using the separator 8, and was made to be a test cell A8.

### Example 8

A porous membrane 9 was fabricated as in Example 6, except for adding 70 parts by mass of the cellulose fibers D and 30 parts by mass of the cellulose fibers E, and was made to be a separator 9. In the pore diameter distribution of the porous membrane 9 measured by a Perm-Porometer, pores having a pore diameter in the range of 0.05 μm or smaller accounted for 60% of the entire pore volume, and the maximum pore diameter of the porous membrane 9 was 0.2 μm. The membrane thickness of the porous membrane 9 was 5 μm. Then, a test cell was fabricated as in Example 6, except for using the separator 9, and was made to be a test cell A9.

### Example 9

A porous membrane 10 was fabricated as in Example 6, except for adding 50 parts by mass of the cellulose fibers D and 50 parts by mass of the cellulose fibers E, and was made to be a separator 10. In the pore diameter distribution of the porous membrane 10 measured by a Perm-Porometer, pores having a pore diameter in the range of 0.05 μm or smaller accounted for 50% of the entire pore volume, and the maximum pore diameter of the porous membrane 10 was 0.1 μm. The membrane thickness of the porous membrane 10 was 30 μm. Then, a test cell was fabricated as in Example 6, except for using the separator 10, and was made to be a test cell A10.

### Example 10

A porous membrane 11 was fabricated as in Example 6, except for adding 80 parts by mass of the cellulose fibers D and 20 parts by mass of the cellulose fibers E, and was made to be a separator 11. In the pore diameter distribution of the porous membrane 11 measured by a Perm-Porometer, pores having a pore diameter in the range of 0.05 μm or smaller accounted for 80% of the entire pore volume, and the maximum pore diameter of the porous membrane 11 was 0.15 μm. The membrane thickness of the porous membrane 11 was 5 μm. Then, a test cell was fabricated as in Example 6, except for using the separator 11, and was made to be a test cell A11.

### Example 11

A porous membrane 12 was fabricated as in Example 6, except for adding 30 parts by mass of the cellulose fibers D and 70 parts by mass of the cellulose fibers E, and was made to be a separator 12. In the pore diameter distribution of the porous membrane 12 measured by a Perm-Porometer, pores having a pore diameter in the range of 0.05 μm or smaller accounted for 40% of the entire pore volume, and the maximum pore diameter of the porous membrane 12 was 0.2 μm. The membrane thickness of the porous membrane 12 was 25 μm. Then, a test cell was fabricated as in Example 6, except for using the separator 12, and was made to be a test cell A12.

### Comparative Example 2

A porous membrane 13 was fabricated as in Example 6, except for adding 40 parts by mass of the cellulose fibers D and 60 parts by mass of the cellulose fibers E, and was made to be a separator 13. In the pore diameter distribution of the porous membrane 13 measured by a Perm-Porometer, pores having a pore diameter in the range of 0.05 μm or smaller accounted for 60% of the entire pore volume, and the maximum pore diameter of the porous membrane 13 was 0.3 μm. The membrane thickness of the porous membrane 13 was 25 μm. Then, a test cell was fabricated as in Example 6, except for using the separator 13, and was made to be a test cell A13.

Table 2 shows the maximum pore diameters, the ratios of pores having a pore diameter in the range of 0.05 μm or smaller and the membrane thicknesses of the porous membranes in Examples 6 to 11 and Comparative Example 2.

TABLE 2

| | Porous Membrane | | |
|---|---|---|---|
| | | Ratio of Pores Having | |
| | Maximum Pore | a Pore Diameter of 0.05 | Membrane |
| | Diameter (μm) | μm or Smaller (%) | Thickness (μm) |
| Example 6 | 0.2 | 60 | 15 |
| Example 7 | 0.1 | 80 | 20 |
| Example 8 | 0.2 | 60 | 5 |
| Example 9 | 0.1 | 50 | 30 |
| Example 10 | 0.15 | 80 | 5 |
| Example 11 | 0.2 | 40 | 25 |
| Comparative | 0.3 | 60 | 25 |
| Example 2 | | | |

[Evaluation of the Battery Capacity]

The fabricated test cells A7 to A13 were each repeatedly subjected to a cycle of such charge/discharge that the test cell was charged at a constant current of 200 mA until the cell voltage reached 4.2 V, further charged at a constant voltage of 4.2 V until the current value became 50 mA, and thereafter, discharged at a constant current of 200 mA until the cell voltage reached 3 V. Then, the discharge capacity at the third cycle was taken to be a battery capacity.

[Evaluations of the Internal Short Circuit and the Input/Output]

The fabricated test cells A7 to A13 were each repeatedly subjected to a cycle of such charge/discharge that the test cell was charged at a constant current of 2,000 mA until the cell voltage reached 4.2 V, further charged at a constant voltage of 4.2 V until the current value became 100 mA, and thereafter, discharged at a constant current of 1,000 mA until the cell voltage reached 3 V.

Table 3 shows the results of the battery capacities, the internal short circuit and the input/output in Examples 6 to 11 and Comparative Example 2.

TABLE 3

| | | Internal | | |
|---|---|---|---|---|
| | Battery Capacity | Short | Battery Capacity | |
| | (at the Third | Circuit | (at the 500th | Input/ |
| | Cycle) (mAh) | (cycles) | Cycle) (mAh) | output (%) |
| Example 6 | 980 | — | 830 | 85 |
| Example 7 | 960 | — | 720 | 75 |
| Example 8 | 990 | — | 690 | 70 |
| Example 9 | 985 | — | 840 | 85 |
| Example 10 | 970 | — | 680 | 70 |
| Example 11 | 990 | 80 | — | — |
| Comparative | 920 | 30 | — | — |
| Example 2 | | | | |

In the evaluation of the battery capacity at the third cycle, all of the test cells of Examples 6 to 11 and Comparative Example 2 exhibited a high battery capacity. In the evaluation of the internal short circuit and the input/output, the test cell A12 of Example 11 and the test cell A13 of Comparative Example 2 suffered an internal short circuit at the 80th cycle, and the 30th cycle, respectively. However, since compared with the test cell A12 of Comparative Example 2, in which the maximum pore diameter of the porous membrane was made to be 0.3 μm, the test cell A12 of Example 11 in which the maximum pore diameter of the porous membrane was made to be 0.2 μm exhibited an increased number of cycles until the internal short circuit occurred, it can be said that the test cell A12 of Example 11 better suppressed the occurrence of the internal short circuit than the test cell A13 of Comparative Example 2. When the test cell A12 of Example 11 and the test cell A13 of Comparative Example 2 were disassembled, lithium dendrite was found to penetrate the separator. By contrast, the test cells A7 to A11 of Examples 6 to 10, though having been subjected to a 500-cycle charge/discharge, suffered no internal short circuit, and the proportion (input/output) of a battery capacity at the 500th cycle to a battery capacity at the third cycle was maintained at 70% or higher, so it can be said that decrease of the input/output was suppressed. That is, by using a separator having a porous membrane in which the maximum pore diameter of the porous membrane was 0.2 μm or smaller and pores having a pore diameter in the range of 0.05 μm or smaller accounted for 50% or more of the entire pore volume in the pore diameter distribution of the porous membrane, the occurrence of the internal short circuit caused by lithium dendrite was better suppressed and the decrease of the input/output was better suppressed than the case where a separator was used which had a porous membrane in which the maximum pore diameter of the porous membrane was 0.3 μm or larger or pores having a pore diameter in the range of 0.05 μm or smaller accounted for less than 50% of the entire pore volume in the pore diameter distribution of the porous membrane.

### REFERENCE SIGNS LIST

1 NEGATIVE ELECTRODE, 2 POSITIVE ELECTRODE, 3 SEPARATOR, 4 BATTERY CASE, 5 SEALING PLATE, 6 UPPER INSULATING PLATE, 7 LOWER INSULATING PLATE, 8 POSITIVE ELECTRODE LEAD, 9 NEGATIVE ELECTRODE LEAD, 10 POSITIVE ELECTRODE TERMINAL, 30 NON-AQUEOUS ELECTROLYTE SECONDARY BATTERY, 40 FIBER, 41 PATH THROUGH WHICH Li IONS PASS, and 42 LITHIUM DENDRITE

1. A separator for non-aqueous electrolyte secondary battery, comprising a porous membrane comprising cellulose fibers as a main component thereof,
wherein a maximum pore diameter of the porous membrane 0.2 μm or smaller.

2. The separator for non-aqueous electrolyte secondary battery according to claim 1, wherein the maximum pore diameter of the porous membrane is 0.05 μm or smaller.

3. The separator for non-aqueous electrolyte secondary battery according to claim 2, wherein the maximum pore diameter of the porous membrane is in the range of 0.03 μm or smaller.

4. The separator for non-aqueous electrolyte secondary battery according to claim 2, wherein in a pore diameter distribution of the porous membrane, pores having a pore diameter in the range of larger than 0.01 μm and 0.03 μm or smaller accounts for 10% or more and 50% or less of an entire pore volume.

5. The separator for non-aqueous electrolyte secondary battery according to claim 2, wherein a thickness of the porous membrane is in the range of 5 μm or larger and 30 μm or smaller.

6. The separator for non-aqueous electrolyte secondary battery according to claim 2, wherein a fiber diameter of the cellulose forming the porous membrane is 1/10th or less of a thickness of the porous membrane.

7. The separator for non-aqueous electrolyte secondary battery according to claim 2, wherein an average fiber diameter of the cellulose forming the porous membrane is 0.5 μm or smaller.

8. A non-aqueous electrolyte secondary battery, comprising:
a positive electrode;
a negative electrode;
the separator for non-aqueous electrolyte secondary battery according to claim 2 interposed between the positive electrode and the negative electrode; and
a non-aqueous electrolyte.

9. The separator for non-aqueous electrolyte secondary battery according to claim 1,
wherein the maximum pore diameter of the porous membrane is 0.2 μm or smaller; and
wherein in a pore diameter distribution of the porous membrane, pores having a pore diameter in the range of 0.05 μm or smaller accounts for 50% or more of an entire pore volume.

10. The separator for non-aqueous electrolyte secondary battery according to claim 9, wherein a thickness of the porous membrane is in the range of 5 μm or larger and 30 μm or smaller.

11. The separator for non-aqueous electrolyte secondary battery according to claim 9,
wherein the maximum pore diameter of the porous membrane is 0.1 μm or larger and 0.2 μm or smaller; and
wherein in the pore diameter distribution of the porous membrane, the pores having a pore diameter in the range of 0.05 μm or smaller accounts for 50% or more and 80% or less of the entire pore volume.

12. The separator for non-aqueous electrolyte secondary battery according to claim 9, wherein a content of cellulose fibers having a fiber diameter of 5 μm or smaller and a fiber length of 50 μm or shorter in the cellulose fibers is in the range of 50% or more and 80% or less with respect to a total amount of the cellulose fibers.

13. A non-aqueous electrolyte secondary battery, comprising:
a positive electrode;
a negative electrode;
the separator for non-aqueous electrolyte secondary battery according to claim 9 interposed between the positive electrode and the negative electrode; and
a non-aqueous electrolyte.
